(19) United States
(12) Patent Application Publication
(10) Pub. No.: US 2015/0065002 A1
(43) Pub. Date: Mar. 5, 2015

(54) MULTILAYER PROTECTIVE FABRIC COVERING MATERIAL

(71) Applicant: Stedfast, Inc., Granby (CA)

(72) Inventor: Hamid Benaddi, Granby (CA)

(73) Assignee: Stedfast, Inc., Granby (CA)

(21) Appl. No.: 14/059,539

(22) Filed: Oct. 22, 2013

(30) Foreign Application Priority Data
Aug. 29, 2013 (CA) 2825447

(51) Int. Cl. A41D 13/00; B32B 37/18

(52) U.S. Cl. CPC A41D 13/0002; B32B 37/182
USPC 442/268; 442/319; 156/60

(57) ABSTRACT

A multilayer protective fabric material covering for providing protection against chemical, biological, radiation and nuclear material (CBRN), especially in the form of aerosols or microbes, protective equipment or garments made from such material, and methods of manufacturing the material. The protective fabric material comprises a fabric shell layer and a second layer, adjacent to the fabric shell layer, the second layer comprising three sublayers which may be laminated together to form a sandwich layer. The first sublayer is a non-woven microporous membrane which is at least partly impermeable to aerosols, microbes or a combination thereof, and which is at least partly permeable to air, which may comprise polyurethane, Teflon™, or some other suitable polymer. The second sublayer is a comfort or moisture wicking layer comprising woven or knitted fabric. The third sublayer comprises activated carbon material.

### CROSS REFERENCE TO RELATED APPLICATION

This application claims the benefit of Canadian Patent Application No. 2,825,447 filed Aug. 29, 2013, the disclosure of which is hereby incorporated herein by reference in its entirety.

### TECHNICAL FIELD

This invention generally relates to a multilayer protective fabric covering material and methods for making a multilayer protective fabric covering material. More particularly, this invention relates to a protective fabric covering having multiple layers including a non-woven microporous layer, for providing protection from aerosols and microbes. The protective fabric covering has military and non-military applications, for example can be used for hunting gear.

### BACKGROUND

Military and civilian personnel, supplies and equipment are increasingly at risk of being placed in emergency roles that involve potential exposure to weaponized or non-weaponized chemical, biological, radiological and nuclear materials (CBRN). CBRN exposure may arise in a variety of contexts, such as during a disease outbreak, in the wake of a natural disaster near a nuclear or chemical facility, or in the event of a terrorist or state-sponsored military attack.

In non-military applications, there is a need for protective fabric covering, which is constructed so as to prevent the chemical scent of the wearer from escaping from the fabric covering.

Much of the risk associated with CBRN exposure arises due to microbes and aerosol-borne CBRN. Accordingly, any protection against CBRN exposure will be less effective, or completely ineffective, if it does not provide protection from microbes and aerosols. At the same time, it is desirable to provide CBRN protection with a covering that does not carry too high of a thermal burden to individuals wearing clothing or uniforms made from the fabric. Some degree of permeability to air and moisture is therefore desirable.

Protective fabric coverings which provide some protection from CBRN are known in the art. Boopathi et al. provide a general review of the field of protective coverings in their article “A Review on NBC Body Protective Clothing”, published in The Open Textile Journal, 2008, 1, 1-8. This article discusses the historical development of protective coverings, and the overall desirability of protective fabric coverings that are permeable to air while providing protection against nuclear, biological, and/or chemical materials.

U.S. Pat. No. 7,704,598 to Jain et al. describes a protective covering comprising a non-woven microporous film attached to a functional layer.

U.S. Pat. No. 5,731,065 to Stelzmuller et al. describes a multilayered, textile, gas-permeable filter material intended to provide protection against toxic chemical substances.

The protective fabric coverings known in the art suffer from a number of drawbacks, including failure to provide a level of protection consistent with some modern day threats, and failure to provide a functional covering which may form part of an integrated tactical system. Furthermore, protective fabric coverings known in the art fail to provide a sufficiently low thermal burden in order to provide useful protection under circumstances where heat strain tolerance is desired. Among other things, the heavy weight and rigidity of the protective fabric coverings known in the art result in coverings which are uncomfortable and awkward for the wearer.

Accordingly, there is a need in the art for a protective fabric covering which may be used in the fabrication of uniforms, for example combat uniforms, protective clothing, bevy bags, or any other application where protection from CBRN hazards including aerosols and microbes is required, and where minimal additional thermal burden and weight, relative to standard combat uniforms is desirable.

### SUMMARY

The present invention relates to a protective fabric covering material comprising multiple adjacent layers. The first layer is a fabric shell, which may be treated with a durable water repellent (DWR). The second layer has at least three sublayers. The first sublayer comprises a non-woven microporous polymer membrane which is impermeable to aerosols and microbes and which is permeable to air. The second sublayer comprises woven or knitted fabric, this sublayer preferably being a comfort layer for enhancing comfort of a wearer. The third sublayer comprises an activated carbon material. The third sublayer can also be impregnated with a moiety which can neutralize CBRN materials.

In one embodiment, the non-woven microporous polymer material membrane of the second sublayer may comprise a polytetrafluorocarbon, such as polytetrafluoroethylene (Teflon™), or polyurethane, or any other suitable polymer which is impermeable to aerosols and microbes.

In another embodiment, the sublayers of the second layer may be arranged such that the first sublayer is nearest the fabric shell layer and the second sublayer is farthest from the fabric shell layer. In yet another embodiment, the multiple sublayers of the second layer may be arranged in any order.

In yet another embodiment, the three sublayers may be arranged such that each sublayer is adjacent to at least one of the other two sublayers.

In an embodiment, two or more of the sublayers may be laminated together to form a “sandwich” layer. In certain embodiments, the shell layer may be laminated to one or more of the sublayers. Accordingly, in certain embodiments, any one of the shell layer and the sublayers may be laminated together to form one or more “sandwich layers”.

In yet another embodiment, the aerial density loading of the multilayer protective fabric covering material may be varied. In certain embodiments, the aerial density loading may be increased to increase aerosol filtration efficiency, or the aerial density may be decreased to decrease the aerosol filtration efficiency.

In yet another embodiment, the permeability to air of the multilayer protective fabric covering material is greater than 0 and less than 25 cubic feet per minute per square metre (CFM).

In yet another embodiment, the first sublayer is at least partly impermeable to particles having diameters between 300 nm and 5 μm. As used herein, the term “is at least partially impermeable” means having a degree of impermeability of about 90% or greater. In yet another embodiment, the first sublayer is at least partly impermeable to particles having diameters between 400 nm and 3 μm. In certain embodiments, the impermeability to particles of the first sublayer is 90% or greater, 95% or greater, or 100% filtration efficiency in a standard swatch filtration test.

In another embodiment, a protective garment is made from the multilayer protective fabric covering material of the invention.

The present invention also relates to a method of manufacturing a protective fabric covering material comprising multiple adjacent layers. The method comprises: providing a fabric shell layer, optionally treating this shell layer with a durable water repellent; providing a first sublayer comprising a non-woven microporous polymer membrane which is impermeable to aerosols and microbes and which is permeable to air; providing a second sublayer comprising a woven or knitted fabric, this sublayer preferably being a comfort layer for enhancing comfort of a wearer; providing a third sublayer comprising activated carbon material, and arranging this layer adjacent to at least one of the first sublayer and the second sublayer, arranging the sublayers adjacent to one another; and arranging the shell layer adjacent to one of the sublayers, to form the multilayer protective fabric covering material.

The non-woven microporous polymer material membrane of the first sublayer may comprise a polytetrafluorocarbon, such as polytetrafluoroethylene (Teflon™), or polyurethane, or any other suitable polymer which is impermeable to aerosols and microbes.

In yet another embodiment, the method additionally comprises a step of arranging the sublayers such that the first sublayer is nearest the fabric shell layer and the second sublayer is farthest from the fabric shell layer. In another embodiment, the multiple sublayers may be arranged in any order.

The method of manufacture may involve the additional step or steps of laminating together the sublayers to form a “sandwich” layer. The method can additionally comprise the step of laminating the shell layer to one or more of the sublayers. The method may comprise laminating together any one of the shell layer and the sublayers to form one or more “sandwich layers”.

### BRIEF DESCRIPTION OF THE DRAWINGS

FIG. 1 is a schematic diagram depicting the protective fabric covering material according to one embodiment of the present invention.

FIG. 2 is a penetration curve showing the particle diameter versus the penetration velocity and illustrates the degree of protection provided by a first swatch of the protective fabric of the invention.

FIG. 3 is a penetration curve showing the particle diameter versus the penetration velocity and illustrates the degree of protection provided by a second swatch of the protective fabric of the invention.

### DETAILED DESCRIPTION OF THE EMBODIMENTS

As used herein, the first sublayer is impermeable to aerosols and microbes where the penetration velocity of the particles into the sublayer is less than 2.5 cm/sec for particles with a geometric mean diameter of 0.75 micrometer and larger, more preferably less than 0.5, and even more preferably less than 0.20.

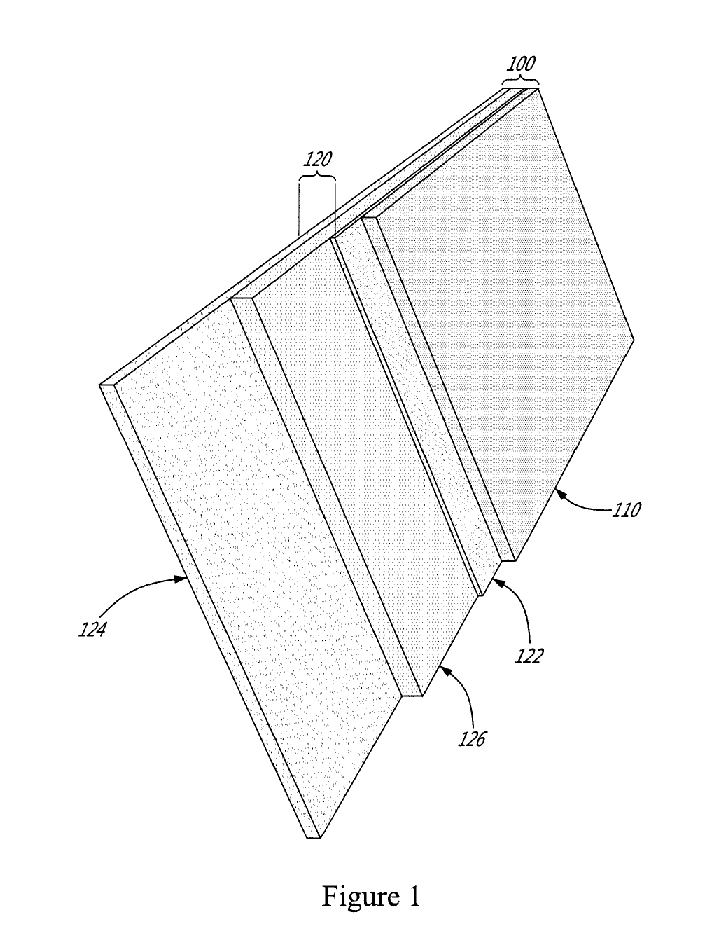

With reference to FIG. 1, the multilayer protective fabric covering (100) shown comprises, in the order of their arrangement: a fabric shell first layer (110), which may be treated with DWR; a second layer (120), comprising a first sublayer (122); a second sublayer (124); and a third sublayer (126). In another embodiment, the sublayers may be arranged in any order relative to one another.

In the embodiment depicted in FIG. 1, the first sublayer (122) is an aerosol filter layer, comprising a non-woven microporous membrane comprising a polymer material. In a preferred embodiment, the polymer material may comprise a polytetrafluorocarbon or polyurethane. In another preferred embodiment, the polymer material may comprise polytetrafluoroethylene (Teflon™).

The non-woven microporous membrane is at least partly impermeable to aerosols and microbes, and thereby provides protection against CBRN in aerosol or microbe form. It has been surprisingly found that the multilayer protective fabric material of the present invention provides a high degree of protection against aerosols. In order to provide increased heat strain tolerance, the non-woven microporous membrane is permeable to air.

In a preferred embodiment, the non-woven microporous membrane may be selected according to its aerial density loading characteristics, which provide desired aerosol filtration characteristics. Non-woven microporous membranes which provide higher aerial density loading will provide increased aerosol filtration efficiency, while membranes which provide decreased aerial density loading will provide decreased filtration efficiency. The filtration performance of the membrane, and of the multilayer protective fabric covering (100) is therefore variable according to the specific aerosol hazard.

In preferred embodiments, the non-woven microporous membrane is at least partly impermeable to, and therefore provides protection against, particles having a diameter between 300 nm and 5 μm, and more preferably 400 nm and 3 μm. In certain embodiments, the membrane provides 90% or greater, 95% or greater, or 100% filtration efficiency against particles having these diameters in a standard swatch filtration test.

In yet another preferred embodiment, the non-woven microporous membrane may have an aerial density loading which provides a desired air permeability. Non-woven microporous membranes which provide higher aerial density loading will provide decreased air permeability, while membranes which provide decreased aerial density loading will provide increased air permeability. Accordingly, the heat transfer of the membrane, and of the multilayer protective fabric covering (100) is therefore variable according to the desired evaporative heat transfer. By increasing the aerial density loading, air permeability and therefore evaporative heat transfer is decreased, resulting in a membrane and a multilayer protective fabric covering (100) which is particularly well suited to use in conditions where maintaining heat insulation is desired. Conversely, by decreasing the aerial density loading, air permeability and therefore evaporative heat transfer is increased, resulting in a membrane and a multilayer protective fabric covering (100) which is particularly well suited to use in conditions where reducing heat insulation is desired.

In yet another preferred embodiment, the multilayer protective fabric covering (100) has a permeability to air of 25 cubic feet per minute per metre squared (CFM), or less.

With further reference to FIG. 1, the second sublayer (124) is a comfort layer made of a woven or knitted fabric. This second sublayer (124) may comprise a material or fabric having moisture wicking properties, and may function to provide comfort to the wearer.

With further reference to FIG. 1, the third sublayer (126) is a light weight carbon layer comprising activated carbon. It has been found that inclusion of a light weight activated carbon layer (126) in a multilayer protective fabric material of the present invention provides protection against CBRN materials as the activated carbon is thought to adsorb chemicals and thus provides a filtering effect with respect to toxic chemicals, biological gases and aerosols. The activated carbon layer can also be impregnated with a moiety which can neutralize one or more CBRN materials, such as polyethylenimine, inorganic chemicals such as metals, or polyoxometalate-metal organic framework (POM-MOF) materials. Examples of such moieties are disclosed in U.S. Pat. No. 6,410,603 (which is incorporated by reference in its entirety).

In the embodiment depicted in FIG. 1, the three sublayers (122, 126, 124) are laminated together with suitable lightweight adhesive material to form a single “sandwich” layer (120), and the fabric shell layer (110) in arranged adjacent the “sandwich”, but not laminated thereto. In another embodiment, none of the layers (110, 120) or the sublayers (122, 124, 126) are laminated together. In still another embodiment, any two or more of the fabric shell layer (110) and the sublayers (122, 124, 126) may be laminated together.

The sublayers can be laminated to each other using adhesives and lamination techniques which are known in the art, including spray adhesive, gravure roll lamination, web adhesive, hot melt adhesive, solvent base adhesive, and water base adhesive.

The invention also relates to a method of manufacturing a multilayer protective fabric covering (100). In one embodiment, the method comprises the step of providing a fabric shell layer (110), which is optionally treated with DWR and which has two surfaces, and a step of providing a first sublayer (122) having two surfaces and comprising a non-woven microporous membrane which is a polymer material and which is impermeable to microbes, aerosols or a combination thereof, and which is permeable to air. The method also comprises the steps of providing a second sublayer (124) having two surfaces and comprising woven or knitted fabric, and of arranging the fabric shell layer (110) and the sublayers (122, 124) such that a surface of the fabric shell layer (110) is adjacent to a surface of the first sublayer or to a surface of the second sublayer to form the multilayer protective fabric material. In certain embodiments, the second sublayer (124) is a comfort layer for providing comfort to a wearer. The second sublayer (124) may provide moisture wicking properties to the multilayer protective fabric material. The method also comprises the step of providing a third sublayer (126) comprising activated carbon material, and arranging the sublayers (122, 124, 126) such that the third sublayer is sandwiched between the first sublayer (122) and the second sublayer (124).

In a preferred embodiment, the polymer material of the first sublayer (122) comprises polytetrafluorocarbon or polyurethane. In yet another preferred embodiment, the polytetrafluorocarbon is polytetrafluoroethylene (Teflon™).

The method can further comprise the step of arranging the sublayers such that the first sublayer (122) is nearest the fabric shell layer (110) and the second sublayer (124) is farthest from the fabric shell layer (110).

The method can further comprise the step of laminating together any two or more of the sublayers (122, 124, 126) with lightweight adhesive material to form a “sandwich” layer (120). In another embodiment, the method comprises the step of laminating the fabric shell layer (110) to one or more of the sublayers (122, 124, 126).

In a preferred embodiment, the method may further comprise the step of selecting the non-woven microporous membrane according to its aerial density loading characteristics.

As described further in the Examples section below, it has surprisingly been found that the preferred multilayer protective fabric covering (100) of the present invention provides a high degree of protection against particles of representative size to biological spores or radioactive particles, which size corresponds to aerosols and microbes likely to be present in CBRN.

Also as described further in the Examples section below, it has surprisingly been found that the multilayer protective fabric covering (100) of the present invention is relatively lightweight, flexible, and provide a high heat strain tolerance.

It is believed that that the surprisingly advantageous properties of the multilayer protective fabric covering of the present invention are provided by the unique combination of the outer shell layer, the second and third sublayers, and the non-woven microporous membrane comprising a non-woven polymer material such as polytetrafluoroethylene (Teflon™). In particular, the unique aerosol-protecting qualities of the non-woven polymer material are thought to provide a high degree of protection against aerosols and microbes, while at the same time providing a high degree of flexibility and a high heat strain tolerance.

### EXAMPLE

### Example 1

### Performance of Aerosol Penetration

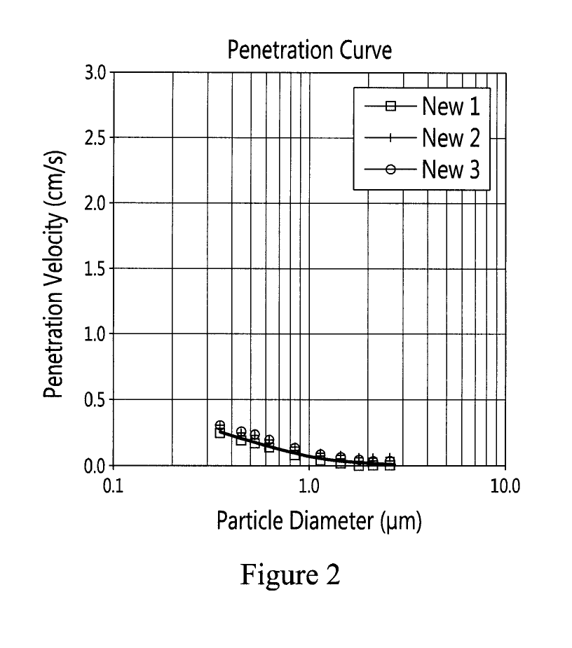

Preferred multilayer protective fabric coverings of the present invention were tested in order to measure the degree of protection provided against aerosol particles. The data shown below in Table A and in the Penetration Curve of FIG. 2 show the results of testing a swatch of a multilayer protective fabric covering in accordance with one embodiment of the present invention, comprising a shell layer made of woven fabric, an aerosol filter sublayer comprising polytetrafluoroethylene (Teflon™), a lightweight activated carbon layer, and a comfort moisture wicking sublayer. In the swatch tested, all three sublayers were laminated together.

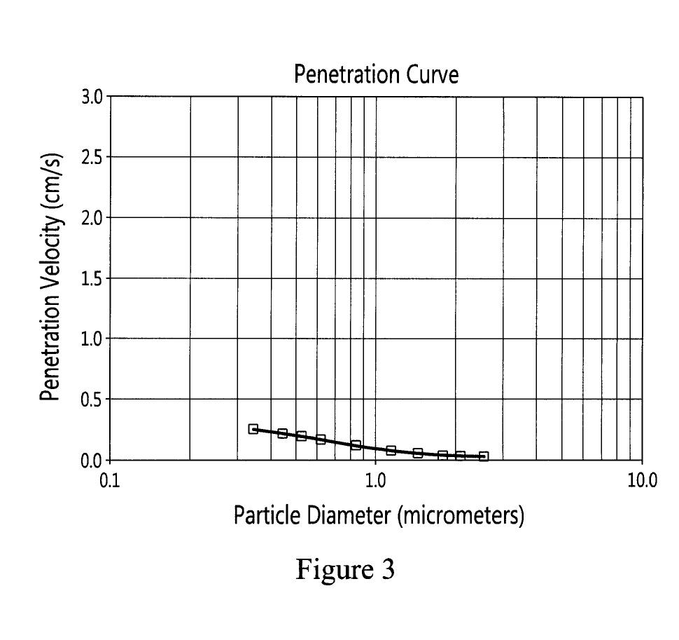

The data shown below in Table B and the accompanying Penetration Curve of FIG. 3 show the results of testing a second swatch of another multilayer protective fabric covering in accordance with a second embodiment of the present invention. This second swatch comprises the same sublayers as the first swatch tested, except that the outer shell layer is made of a knitted fabric.

The first swatch was tested under standard conditions, as follows:

Temperature: 91° F.

Relative humidity: 68%

Test aerosol type: Oleic acid, a low volatility oil organic aerosol (OA)

| Media dP (in. wg) | Face velocity (cm/s) |
|---|---|
| Sample 1: 0.10 | Sample 1: 1.25 |
| Sample 2: 0.10 | Sample 2: 1.25 |
| Sample 3: 0.10 | Sample 3: 1.25 |

Selected efficiency data from the first test were are follows:

| | | |
|---|---|---|
| Average penetration: | 0.21 @ 0.35 μm | 0.02 @ 2.57 μm |
| Average penetration velocity: | 0.12 @ 0.84 μm | |

TABLE A
(Detailed Results from the first sample tests)

| | | | | Particle Size | | | | | | | | | |
|---|---|---|---|---|---|---|---|---|---|---|---|---|---|
| | | | | OPC Channel Number | | | | | | | | | |
| | | | | 1 | 2 | 3 | 4 | 5 | 6 | 7 | 8 | 9 | 10 |
| Min. Diam. (μm) | | | | 0.3 | 0.4 | 0.5 | 0.55 | 0.7 | 1 | 1.3 | 1.6 | 2 | 2.2 |
| Max. Diam. (μm) | | | | 0.4 | 0.5 | 0.55 | 0.7 | 1 | 1.3 | 1.8 | 2 | 2.2 | 3 |
| Geo. Mean Diam (μm) | | | | 0.35 | 0.45 | 0.52 | 0.62 | 0.84 | 1.14 | 1.44 | 1.79 | 2.10 | 2.57 |
| | Face Vel | | | | | | | | | | | | |
| Fabric | cm/s | Filename | | | | | | | | | | | |
| New 1 | 1.33 | SW04031205 | Penetration | 0.19 | 0.15 | 0.13 | 0.11 | 0.07 | 0.03 | 0.02 | 0.01 | 0.01 | 0.01 |
| | | | Penetration Velocity cm/s | 0.28 | 0.20 | 0.18 | 0.14 | 0.09 | 0.04 | 0.03 | 0.01 | 0.01 | 0.01 |
| New 2 | 1.39 | SW04041201 | Penetration | 0.19 | 0.15 | 0.12 | 0.11 | 0.07 | 0.04 | 0.02 | 0.01 | 0.01 | 0.01 |
| | | | Penetration Velocity cm/s | 0.27 | 0.21 | 0.17 | 0.16 | 0.10 | 0.05 | 0.03 | 0.02 | 0.01 | 0.01 |
| New 3 | 1.37 | SW04091201 | Penetration | 0.21 | 0.17 | 0.17 | 0.13 | 0.06 | 0.05 | 0.03 | 0.02 | 0.01 | 0.01 |
| | | | Penetration Velocity cm/s | 0.29 | 0.24 | 0.23 | 0.16 | 0.11 | 0.07 | 0.05 | 0.02 | 0.02 | 0.02 |
| | | | Average Penetration | 0.20 | 0.16 | 0.14 | 0.12 | 0.07 | 0.04 | 0.03 | 0.01 | 0.01 | 0.01 |

| | | | | | | | | | | |
|---|---|---|---|---|---|---|---|---|---|---|
| Average Penetration Velocity (cm/s) | 0.27 | 0.22 | 0.19 | 0.16 | 0.10 | 0.06 | 0.04 | 0.02 | 0.01 | 0.01 |

| | | | | | | | | | | | |
|---|---|---|---|---|---|---|---|---|---|---|---|
| Blank Control Test | Penetration | 0.98 | 0.98 | 0.97 | 1.00 | 1.00 | 1.02 | 1.02 | 1.02 | 0.98 | 0.98 |
| (100% Penetration) | | | | | | | | | | | |
| HEPA Control Test (0% Penetration) | Penetration | 0.000 | 0.000 | 0.000 | 0.000 | 0.000 | 0.000 | 0.000 | 0.000 | 0.000 | 0.000 |

The second swatch was also tested under standard conditions, as follows:

Temperature: 91° F.

Relative humidity: 67%

Test aerosol type: Oleic acid, a low volatility oil organic aerosol (OA)

| Media dP (in. wg) | Face velocity (cm/s) |
|---|---|
| Sample 1: 0.10 | Sample 1: 1.33 |
| Sample 2: 0.10 | Sample 2: 1.39 |
| Sample 3: 0.10 | Sample 3: 1.37 |

Selected efficiency data from the second test were are follows:

| | | |
|---|---|---|
| Average penetration: | 0.20 @ 0.35 μm | 0.01 @ 2.57 μm |
| Average penetration velocity: | 0.10 @ 0.84 μm | |

TABLE B
(Detailed Results from the second sample tested)

| | | | | Particle Size | | | | | | | | | |
|---|---|---|---|---|---|---|---|---|---|---|---|---|---|
| | | | | OPC Channel Number | | | | | | | | | |
| | | | | 1 | 2 | 3 | 4 | 5 | 6 | 7 | 8 | 9 | 10 |
| Min. Diam. (μm) | | | | 0.3 | 0.4 | 0.5 | 0.55 | 0.7 | 1 | 1.3 | 1.6 | 2 | 2.2 |
| Max. Diam. (μm) | | | | 0.4 | 0.5 | 0.55 | 0.7 | 1 | 1.3 | 1.8 | 2 | 2.2 | 3 |
| Geo. Mean Diam (μm) | | | | 0.35 | 0.45 | 0.52 | 0.62 | 0.84 | 1.14 | 1.44 | 1.79 | 2.10 | 2.57 |
| | Face Vel | | | | | | | | | | | | |
| Fabric | cm/s | Filename | | | | | | | | | | | |
| New 1 | 1.33 | SW04031205 | Penetration | 0.19 | 0.15 | 0.13 | 0.11 | 0.07 | 0.03 | 0.02 | 0.01 | 0.01 | 0.01 |
| | | | Penetration Velocity cm/s | 0.28 | 0.20 | 0.18 | 0.14 | 0.09 | 0.04 | 0.03 | 0.01 | 0.01 | 0.01 |
| New 2 | 1.39 | SW04041201 | Penetration | 0.19 | 0.15 | 0.12 | 0.11 | 0.07 | 0.04 | 0.02 | 0.01 | 0.01 | 0.01 |
| | | | Penetration Velocity cm/s | 0.27 | 0.21 | 0.17 | 0.16 | 0.10 | 0.05 | 0.03 | 0.02 | 0.01 | 0.01 |
| New 3 | 1.37 | SW04091201 | Penetration | 0.21 | 0.17 | 0.17 | 0.13 | 0.06 | 0.05 | 0.03 | 0.02 | 0.01 | 0.01 |
| | | | Penetration Velocity cm/s | 0.29 | 0.24 | 0.23 | 0.16 | 0.11 | 0.07 | 0.05 | 0.02 | 0.02 | 0.02 |
| | | | Average Penetration | 0.20 | 0.16 | 0.14 | 0.12 | 0.07 | 0.04 | 0.03 | 0.01 | 0.01 | 0.01 |

| | | | | | | | | | | |
|---|---|---|---|---|---|---|---|---|---|---|
| Average Penetration Velocity (cm/s) | 0.27 | 0.22 | 0.19 | 0.16 | 0.10 | 0.06 | 0.04 | 0.02 | 0.01 | 0.01 |

| | | | | | | | | | | | |
|---|---|---|---|---|---|---|---|---|---|---|---|
| Blank Control Test | Penetration | 0.98 | 0.98 | 0.97 | 1.00 | 1.00 | 1.02 | 1.02 | 1.02 | 0.98 | 0.98 |
| (100% Penetration) | | | | | | | | | | | |
| HEPA Control Test (0% Penetration) | Penetration | 0.000 | 0.000 | 0.000 | 0.000 | 0.000 | 0.000 | 0.000 | 0.000 | 0.000 | 0.000 |

### Example 2

### Isothermal Evaporative Resistance

Preferred multilayer protective fabric coverings of the present invention were tested were tested according to method ISO 11092 Ret—Isothermal Evaporative Resistance. Three samples were tested. As shown in the table below, all data showed a Ret value of less than 7 m²Pa/W.

| | | Efficiency of | |
|---|---|---|---|
| | Air | 0.3 um | |
| | permeability | particles | Ret Skin |
| Samples | cfm/cf2 | filtration | model |
| A | 15 | 84 | 2 |
| B | 10 | 97 | 3 |
| C | 6 | 100 | 6 |

The embodiments of the invention described above are intended to be exemplary only. It will be apparent to the skilled person that various modifications of the present invention can be made. The scope of the claims should not be limited by the preferred embodiments or the examples, but should be given the broadest interpretation consistent with the description as a whole.

1. A multilayer protective fabric material covering comprising:
a fabric shell layer; and
a second layer adjacent to the fabric shell layer, the second layer comprising:
a first sublayer comprising a non-woven microporous membrane, wherein the non-woven microporous membrane comprises a polymer material, and is at least partly impermeable to aerosols, microbes or a combination thereof, and has a permeability to air;
a second sublayer comprising woven or knitted fabric; and
a third sublayer comprising activated carbon material;
wherein each sublayer is adjacent to at least one of the other two sublayers.

2. The multilayer protective fabric covering material of claim 1, wherein the polymer material comprises a polytetrafluorocarbon or polyurethane.

3. The multilayer protective fabric covering material of claim 1, wherein the polymer material comprises polytetrafluoroethylene.

4. The multilayer protective fabric covering material of claim 1, wherein the activated carbon material is impregnated with a moiety, wherein said moiety neutralizes one or more chemical, biological, radiological or nuclear (CBRN) materials.

5. The multilayer protective fabric covering material of claim 4, wherein the moiety is polyethylenimine, an inorganic chemical such as a metal, or a polyoxometalate-metal organic framework (POM-MOF) material.

6. The multilayer protective fabric covering material of claim 1, wherein the sublayers are arranged such that the first sublayer is nearest the fabric shell layer and the second sublayer is farthest from the fabric shell layer.

7. The multilayer protective fabric covering material of claim 1, wherein any two or more of the sublayers are laminated together to form a sandwich layer.

8. The multilayer protective fabric covering material of claim 1, wherein the fabric shell layer is laminated to one or more of the sublayers.

9. The multilayer protective fabric covering material of claim 1, wherein the second sublayer is a comfort layer for providing comfort to a wearer.

10. The multilayer protective fabric covering material of claim 1, wherein the fabric shell layer is treated with a durable water repellent.

11. The multilayer protective fabric covering material of claim 1, wherein the permeability to air is greater than 0 and less than 25 cubic feet per minute per square metre (CFM).

12. The multilayer protective fabric covering material of claim 11, wherein the first sublayer is at least partly impermeable to particles between 300 nm and 5 μm in diameter.

13. The multilayer protective fabric covering material of claim 12, wherein the first sublayer is at least partly impermeable to particles between 400 nm and 3 μm in diameter.

14. The multilayer protective fabric covering material of claim 13, wherein the first sublayer provides a filtration efficiency to the particles of at least 90% in a standard swatch filtration test.

15. The multilayer protective fabric covering material of claim 14, wherein the first sublayer provides a filtration efficiency to the particles of at least 95% in the standard swatch filtration test.

16. The multilayer protective fabric covering material of claim 15, wherein the first sublayer provides a filtration efficiency to the particles of 100% in the standard swatch filtration test.

17. A protective garment made from the multilayer protective fabric covering material of claim 1.

18. A method of manufacturing a multilayer protective fabric covering material, the method comprising:
providing a fabric shell layer;
providing a first sublayer comprising a non-woven microporous membrane, wherein said non-woven microporous membrane is a polymer material and is at least partly impermeable to aerosols, microbes or a combination thereof, and which has a permeability to air;
providing a second sublayer, the second sublayer comprising a woven or knitted fabric;
providing a third sublayer comprising activated carbon material;
arranging the first sublayer and the third sublayer such that the first sublayer is adjacent to the third sublayer;
arranging the fabric shell layer and the sublayers such that the fabric shell layer is adjacent to the first sublayer or to the second sublayer, and
arranging the sublayers such that the third sublayer is adjacent to at least one of the first sublayer and the second sublayer,
to form the multilayer protective fabric covering material.

19. The method of manufacturing of claim 18, wherein the polymer material comprises a polytetrafluorocarbon or polyurethane.

20. The method of manufacturing of claim 19, wherein the polymer material comprises polytetrafluoroethylene.

21. The method of manufacturing of claim 20, further comprising the step of arranging the sublayers such that the first sublayer is nearest the fabric shell layer and the second sublayer is farthest from the fabric shell layer.

22. The method of manufacturing of claim 21, further comprising the step of laminating together any two or more of the sublayers to form a sandwich layer.

23. The method of manufacturing of claim 22, further comprising the step of laminating the fabric shell layer to one or more of the sublayers.

24. The method of manufacturing of claim 23, wherein the second sublayer is a comfort layer for providing comfort to a wearer.

25. The method of manufacturing of claim 24, further comprising treating the fabric shell layer with a durable water repellent.

26. The method of manufacturing of claim 25, wherein the permeability to air is greater than 0 and less than 25 cubic feet per minute per square metre (CFM).

27. The method of manufacturing of claim 26, wherein the first sublayer is at least partly impermeable to particles between 300 nm and 5 μm in diameter.

28. The method of manufacturing of claim 27, wherein the first sublayer is at least partly impermeable to particles between 400 nm and 3 μm in diameter.

29. The method of manufacturing of claim 28, wherein the first sublayer provides a filtration efficiency to the particles of at least 90% in a standard swatch filtration test.

30. The method of manufacturing of claim 29, wherein the first sublayer provides a filtration efficiency to the particles of at least 95% in the standard swatch filtration test.

31. The method of manufacturing of claim 30, wherein the first sublayer provides a filtration efficiency to the particles of 100% in the standard swatch filtration test.
